(19) United States
(12) Patent Application Publication
(10) Pub. No.: US 2024/0301150 A1
(43) Pub. Date: Sep. 12, 2024

(54) LOW-K DIELECTRIC AEROGEL/POLYMER COMPOSITE FILM PREPARATION METHOD

(71) Applicant: Taiwan Aerogel Technology Material Co., Ltd., Tainan (TW)

(72) Inventors: JEAN-HONG CHEN, Tainan (TW); SHIU-SHIU CHEN, Tainan (TW); SHENG-HONG PONG, Tainan (TW); YANG-DUAN LI, Tainan (TW)

(21) Appl. No.: 18/117,540

(22) Filed: Mar. 6, 2023

(51) Int. Cl. C08J 5/18; C08J 3/11; C08K 5/5419

(52) U.S. Cl. CPC C08J 5/18; C08J 3/11; C08K 5/5419; C08J 2300/00

(57) ABSTRACT

The aerogel particles are mixed with organic solvent and dispersed to form an aerogel suspended solution containing the organic solvent, which can be uniformly aerogel/polymer solution with mixed various types of polymers or plastics solution by mixer, and then coated to form an aerogel/polymer composite film, and the steps of which comprises: organic solvent suspension dispersion, polymer solution mixing, coating film formation, drying and winding. The prepared organic solvent aerogel suspended solution can be evenly mixed with the matching polymer solution to form a uniform aerogel/polymer solution, and then the uniform aerogel/polymer solution is made into various thicknesses of aerogel/polymer composite film by the use of coating, laminating, extruding and other processes. The aerogel/polymer composite film has a thermal insulation and low-dielectric properties and can be applied in a dielectric layer of a high-frequency circuit, an insulation layer of a semiconductor device, or communication mobile phone, computer and other applications.

### FIELD OF THE INVENTION

The present invention relates to an aerogel/polymer composite film, and particularly relates to an aerogel particle with low-dielectric constant and low heat transfer coefficient and a preparation method of the aerogel/polymer composite film.

### BACKGROUND OF THE INVENTION

It is well known that the dielectric properties of materials gradually decrease with the increasing of the internal porosity of the material. Therefore, aerogel materials and related aerogel composite materials can become the low-dielectric related products required by the 5G industry. As we all know, aerogel is a porous material with a three-dimensional network microstructure. It has a porosity higher than 80% (even higher than 95%) and has a low density (about 0.005 to 0.2 g/cm³), high specific surface area (500 to 2,000 m²/g), low thermal conductivity (k=15 to 40 mW/mk), low-dielectric properties (Dₖ=0.1 to 2.5), low-dielectric loss (D_{f}<0.001 or less) and other characteristics. Due to the above excellent properties of aerogel materials, it can be used in industrial applications such as high temperature heat insulation, low temperature insulation, sound insulation, and low-dielectric properties. Since the size of the pores inside the porous aerogel is only a few nanometers to tens of nanometers, the aerogel has low thermal conductivity and thermal convection properties. Therefore, the higher the porosity in the microstructure of inorganic aerogels or organic aerogels induces the lower the thermal conductivity and dielectric properties of the materials. Therefore, in the future, such as petrochemical pipelines, metal smelting, building fire protection, thermal insulation, 5G low-dielectric, and high-frequency signal transmission for electric vehicles will all need to use porous aerogels as the first choice for industrial applications. However, it needs to use a large amount of alcohols, ammonia and hydrophobic solvents (such as n-hexane, cyclohexane, benzene, toluene, and xylene) in the current aerogel manufacturing process for performing mixing and solvent-replacement with hydrophobic solvent, and needs to use the surfactants to prevent significant shrinkage and cracking during aerogel manufacturing process. Therefore, in the aerogel manufacturing, although a large amount of organic solvents and surfactants added in the manufacturing process have their effects, they greatly increase the overall cost of aerogel manufacturing and lead to defects in subsequent applications; such as cracking and odor in high temperature environments. Moreover, the product containing a large number of impurities and ions will affect the dielectric properties of the product.

Because aerogel has a large amount of porosity and extremely low density, it has high applicability in applications such as high heat insulation, cold insulation, sound insulation or low-dielectric properties. In the process of gradually moving towards the 5G era, the application of high-frequency transmission urgently requires dielectric materials with low-dielectric constant (Dₖ<2.5) and low signal loss (D_{f}<0.001). The porosity of a material reduces the electrokinetic transport properties, so the higher porosity in the structure of either inorganic or organic materials induces the lower its dielectric properties. Therefore, the high-frequency application of 5G requires porous aerogel materials as the basic materials for high heat insulation, cold insulation, sound insulation and low-dielectric properties.

According to Japanese Laid-Open Patent Publication No. 8-228105, it discloses a method of manufacturing a semiconductor device. In this method, a wet glue film is formed on a substrate, and a solvent impregnated with the wet glue film is evaporated by supercritical and subcritical drying procedures to form an aerogel film. The prepared dry aerogel film still maintains the network structure of the wet glue film, and is a porous material with high porosity and low-dielectric constant. Accordingly, aerogel can be used as a new material for dielectric layers and insulating inner layers. However, the use of supercritical or subcritical drying procedures in the fabrication of transistor structures will lead to disadvantages such as complicated procedures and expensive equipment investment.

“Supercritical drying” means that water and organic solvents are in a supercritical state under high temperature and high pressure, so that the organic solvent and water have gas-liquid mixing properties at the same time, and the solvent is directly vaporized and dried in the supercritical state. Therefore, the residual solvent in the network structure can be removed under the supercritical condition without causing the wet glue to shrink. However, in the preparation of the transistor structure, the time for the low-dielectric film from solution preparation to coating is different. In addition, during the condensation process of the aerogel solution, the silica gel molecules will aggregate and condense immediately, which will cause the viscosity of the aerogel solution to increase with time. When spin coating is performed at a constant rate, the thickness of the film on the substrate also increases. In the same way, the coating thickness of the transistor thin film structure will have different thicknesses as the process time increases, so it is impossible to prepare a high-quality transistor thin film structure.

The traditional preparation method of aerogel is sol-gel reaction, which is mainly made by mixing the precursor, such as alkoxysilane, methyl orthosilicate, and water glass, with organic solvents first, and then an acid catalyst is added to carry out a hydrolysis reaction. After the hydrolysis reaction is carried out for a certain period of time, an alkali catalyst is added to take place the condensation reaction. During the condensation reaction, a sol will gradually be formed, and the molecules in the sol will continue to react and bond so as to gradually form a semi-solid polymer gel. Then, after a period of aging, the gel forms a three-dimensional network structure with stable structure. Finally, n-butanol, n-hexanol, n-hexane, cyclohexane or other solvents can be used for solvent-replacement, and then supercritical drying technology is used to extract and dry the solvent of the aerogel structure. In addition to consuming a large amount of expensive organic solvents and supercritical equipment, the traditional process technology also needs to use alcohols or alkanes for long-term solvent replacement, so the cost of preparing aerogels is high and time-consuming.

On the other hand, the preparation method of hydrophobic aerogel also adopts the sol-gel synthesis method, which is mainly made by mixing the methyl alkoxysilane precursor, such as methyltrimethoxysilane(MTMS) or methyltriethoxysilane(MTES), with organic solvents first, and then an alkali catalyst is added to carry out the hydrolysis reaction. The condensation reaction is carried out after the hydrolysis reaction for a certain period of time, and a sol is gradually formed during the condensation reaction. The molecules of the sol continue to react and bond each other so as to form a semi-solid polymer gel gradually. After a period of aged time, the solvent such as isopropanol, acetone, n-hexane or cyclohexane is used for solvent-replacement for two to three days, so that the hydrophobic gel forms a structurally stable three-dimensional network structure. Finally, the solvent of the aerogel structure is dried by atmospheric drying technology to obtain a porous and dry aerogel block. However, the manufacturing process of the hydrophobic aerogel also needs to consume a large amount of expensive organic solvents, and replaces the solvent with alcohols or alkanes for a long time, so the preparation is time-consuming and expensive.

Because the process technology adopted in the above-mentioned aerogel preparation method all needs to use organic solvents to react and carry out multiple solvent replacements for two to three days, and then uses supercritical drying technology or normal pressure high temperature drying technology to prevent the aerogel structure from shrinking or cracking due to the surface tension of water molecules during the normal pressure drying process. However, multiple solvent replacement techniques and supercritical drying techniques are time-consuming and expensive, which are not conducive to the competitiveness of aerogel mass production and future applications.

“The flexible composite aerogel and its manufacturing method” described in the Republic of China Invention Publication No. TW 201542457 mainly relates to a direct dispersion preparation method of a hydrophilic aerogel. The method of the present invention relates to a flexible composite organic aerogel comprising a textile reinforcement in which an organic aerogel is placed. The organic aerogel is based on a resin at least partly derived from polyhydroxybenzene and formaldehyde, which is a polymeric organogel containing at least one water-soluble cationic polyelectrolyte, or the thermal decomposition product of the gel in the form of the organic aerogel porous carbon monolith, which comprises the pyrolysis product of the at least one water-soluble cationic polyelectrolyte.

“The aerogel composites and the method for preparing the same” described in the Republic of China Invention Publication No. TW 1655094 mainly relates to aerogel composites. The aerogel composites include at least one base layer having an upper surface and a lower surface, and the base layer includes a reinforcing aerogel composition which includes a reinforcing material and a monolithic aerogel frame; a first cover layer includes a first cover material adhered to the upper surface of the base layer; and a second cover layer includes a second cover material adhered to the lower surface of the base layer. At least a portion of the monolithic aerogel frame of the base layer extends into a portion of both the first cover layer and the second cover layer. The first cover material and the second cover material may each consist essentially of elastic fibers such as spandex, nylon, lycra, spring fibers or combinations thereof, or consists mainly of elastic fibers. However, the prepared aerogel covering material contains elastic fibers or soft polymer sheets, and the used adhesive materials are also organic adhesives such as acrylate, urethane, and hot melt adhesive. Although related soft products have good encapsulation properties for aerogels.

“The aerogel composites and its preparation method” described in the Republic of China Invention Publication No. TW 1663062 comprises: wetting at least one of inorganic fibers and organic fibers to form a fibrous material; laminating the wetted fibrous material and a spacer in a roll-up configuration or a planar form; filling the fibrous material into a container; injecting a precursor into the container and gelling the precursor at the same time to remove residual air bubbles under vacuum so as to prepare a gel-fiber composite; taking the aerogel-fiber composite from the container and removing the spacer; utilizing solvent substitution and organic surface modification to deal with the gel-fiber composite, and then drying the organic surface-modified gel-fiber composite by atmospheric pressure drying or supercritical drying.

“The laminated body comprising the reinforced aerogel composites” described in the Republic of China Invention Publication No. TW 1743082 relates to an aerogel composites material. The aerogel composites material includes at least one base layer having a top surface and a bottom surface, and the base layer includes a reinforced aerogel composition and a monolithic reinforced aerogel frame. The reinforced aerogel composition includes a reinforcing material, a first facing layer comprising a first facing material attached to the top surface of the base layer, and a second facing layer comprising a second facing material attached to the bottom surface of the base layer. At least a portion of the monolithic aerogel frame of the base layer extends to at least a portion of both the first and second facing layers. The first facing material and the second facing material each consist essentially of the fluoropolymer materials.

“The Manufacturing Method of Aerogel Felt” described in the Republic of China Invention Publication No. TW 1765609 relates to a manufacturing method of aerogel felt, which firstly injects aerogel slurry into a glass fiber felt. Then, the soaking liquid is used to form a closed coating layer on the surface of the glass fiber felt to avoid the phenomenon of particle falling off during the storage, transportation and use of the aerogel felt. Therefore, it can be ensured that the amount of aerogel in the aerogel felt does not decrease, thereby not affecting the thermal insulation performance of the aerogel felt, wherein the closed coating layer is selected from acrylic emulsion, talc, VAE emulsion and water-based curing agent mixture.

“The non-woven/aerogel composite fireproof/insulation material and its preparation method” described in the Republic of China Invention Publication No. TW 1535658 invented by our team is disclosed to prepare an aerogel through a hydrolysis step and a condensation step, then in the forming step, and the aerogel is taken and added to a non-woven fabric so that the aerogel is fully interspersed in the non-woven fabric and a drying process is performed to form a non-woven/aerogel composite fireproof/thermal insulation material through making the aerogel fully interpenetrate in the non-woven fabric by impregnation processing or continuous rolling. The conditions of this drying process are drying anhydrous aerogels at normal temperature and pressure or using the organic solution between 30° C. and 80° C. for rapid vaporization and drying.

“Manufacturing Electronic Devices Using Low-K Dielectric Materials” described in the U.S. Pat. No. 8,945,677B2 mainly uses low-dielectric materials (including polyimide aerogels) as manufacture materials and methods for making electronic equipment and semiconductor components. This patent provides a method for manipulating dielectric material properties and affecting the overall dielectric properties of a system. Specifically, a polyurethane polyimide pre-sol, a catalyst and a polar solvent are mixed to form a sol mixture layer, and then the sol components are cross-linked to form a wet gel material. Moreover, the solvent contained in the wet gel material is removed by supercritical fluid to form a polyimide aerogel film. This technique was used to combine a surface of non-porous and low-k template substrate with the polyimide aerogel film. The low-K dielectric materials are used to manufacture electronic equipment in the patent and the supercritical fluid technology is used for multiple steps of solvent removal by pressure cycling. The overall technology is time-consuming and costly, and the manufacturing process takes too long time, which is not cost-effective.

“The Aerogel Insulation Panel and Its Manufacturing” described in the Chinese Invention Patent Publication No. CN105189104A mainly uses polyimide aerogel to prepare an insulation panel, which can be applied to laminated panels for aerospace applications. The panel includes a polyimide aerogel surface layer and a reflective protective layer on the surface layer. The manufacturing process of the polyimide aerogel in the patent includes: (a) forming a polyimide solution by polymerizing a mixture of dianhydride and diamine monomers in a bipolar alkaline solvent (DMAc or NMP); (b) casting the polyimide solution into the fibrous flock; (c) using acetic anhydride and pyridine gel polyamide solution by chemical imidization reaction; (d) using supercritical or sub-supercritical CO₂ drying technology to transfer solvent removal from gels to form fiber/polyimide aerogel composites. The overall technology is time-consuming and costly, and the manufacturing process takes too long time, which is not in line with cost-effectiveness and competitiveness.

The “Method for Preparing Cross-Linked Polyimide Aerogel” in the Chinese Invention Patent Publication No. CN108203516A mainly adopts the sol-gel method, which includes: (a) forming a polyimide solution by polymerizing a mixture of dianhydride and diamine monomers in a bipolar alkaline solvent (DMAc or NMP); (b) casting the polyimide solution into the fibrous flock; (c) using acetic anhydride and pyridine gel polyamide solution by chemical imidization reaction; and (d) using supercritical or sub-supercritical CO₂ drying technology to remove solvent from gels to form fiber/polyimide aerogel composites. The overall technology is time-consuming and costly, and the manufacturing process takes too long time, which is not in line with cost-effectiveness and competitiveness.

Due to the traditional technology for making porous aerogels, the sol-gel reaction process requires the addition of a large amount of organic solvents, acid-base ions, and the use of surfactants or other additives. Therefore, long-term solvent replacement and rinsing with deionized water are required in the process to maintain the stability of the aerogel structure during the drying process and to prepare products with appropriate low-dielectric properties. In addition, the use of supercritical or sub-supercritical CO₂ drying technology to remove the solvent in the gel can effectively prepare aerogel materials with excellent quality.

In addition, the use of polyamide acid solution is combined with supercritical or sub-supercritical CO₂ drying technology to remove the solvent in the polyimide gel so as to prepare pure polyimide aerogel or fiber/polyamide aerogel with a large number of pore structures. However, the dielectric constant of the polyimide aerogel prepared by the related technology cannot be significantly reduced to 3.5, and its dielectric loss is still maintained at 0.003. Because the chemical structure of the polyimide contains a large number of dipole structures and hydrophilic groups, the dielectric constant or dielectric loss of the material cannot be significantly reduced.

### SUMMARY OF THE INVENTION

According to the technology of “low-dielectric aerogel and its preparation method” disclosed by the applicant in Taiwan Invention Patent Application No. 110106194, the rapid condensation technology is used to reduce the linear shrinkage of bulk aerogel, and it is not necessary to soak the aerogel wet glue in a solvent for solvent replacement, so the aerogel structure can be prepared quickly. This prior technology uses rapid gel technology to rapidly form a gel structure, and rinses in deionized water to remove ions from the structure to reduce ion accumulation during subsequent applications. In addition, in the overall process, steps such as removing the wet gel film in liquid immersion and using supercritical fluid technology to remove the solvent can surprisingly be aged within a few minutes to obtain a porous low-dielectric film. However, a lot of process time will be wasted and a lot of washing wastewater will be produced due to the use of deionized water to wash the aerogel material.

Therefore, in order to improve the shortcomings of the low-dielectric aerogel product manufacturing process in the past and produce a large number of low-dielectric and high-purity (low impurity content) aerogel submicron particles, the preparation method provided by the present invention can be used to prepare extremely low-dielectric loss (<0.001) aerogel particles; in addition, during the preparation process, the particles are suspended and mixed with photoelectric-grade organic solvents to form an aerogel suspension solution, and the aerogel suspension solution is mixed with various polymer solutions to control various dielectric constants and dielectric loss of aerogel/polymer composite materials and related products can be applied to future 5G high-frequency electronic components. The present invention can improve the shortcomings in the preparation of current 5G application products, such as uneven structure of low-dielectric aerogels, insignificant reduction in aerogel dielectric properties or dielectric loss, and the application of supercritical drying technology with difficulties in the preparation of integrated circuit structures and other issues.

At present, there are two major technical difficulties in the preparation of aerogel mixing polymer solution: first, one is low-density aerogel (0.01±0.05 g/cm³) and polymer solution (1.0±0.3 g/cm³). During the mixing process, the aerogel cannot be dispersed with the polymer solution to form agglomerates due to the density difference between the aerogel and the polymer solution; second, aerogel is a porous material. When the aerogel is mixed with the polymer solution, the aerogel will also absorb the polymer solution and make the polymer solution penetrate into the aerogel structure, so that the pores of the aerogel will be filled with polymer and disappear, resulting in the loss of the aerogel pore structure. Therefore, this patent expects to improve the above shortcomings and develop a manufacturing technology and a film-forming technology that can be uniformly mixed with the polymer solution and prevent the polymer solution from penetrating into the pores of the aerogel.

On the one hand, the present invention provides aerogel particles with low-dielectric and low thermal conductivity, and on the other hand, it provides a preparation method of aerogel/polymer film. In the preparation of the aerogel particles with low-dielectric and low thermal conductivity, the sol-gel synthesis technology with low content of organic solvents (such as ethanol and other solvents) and extremely low acid and alkali catalyst concentrations is used. Under no adding surfactants and other additives, the process technology of preparing high-purity, low-dielectric and low thermal conductivity aerogel particle includes the following steps: (1) a mixing hydrolysis step: mixing a siloxane compound (such as TEOS) or a hydrophobically modified siloxane compound (such as MTMS) or a mixture thereof in a trace acid catalyst and a large amount of recovery solvent (including water, ethanol, and other trace organic solvent) or a new solvent to form a homogeneous solution, and the hydrolysis reaction is carried out during the mixing process; (2) a condensation dispersion step: adding the hydrolyzed silicon molecule solution to a large amount of recovery solvent (including water, ethanol, and other trace organic solvents) containing a small amount of alkali catalyst or a large amount of dispersion solution, and using emulsifiers, homogenizers, turbine mixers and other high-speed stirring to disperse the hydrolyzed silicon molecular solution in a large amount of dispersion solution (containing a small amount of alkali catalyst) into nanometer to submicron suspended silicon-containing molecular wet-sol droplets, and under the condition of high-speed stirring and dispersing, the suspended silicon-containing molecular wet-sol droplets of nanometer to submicron size are condensed under the catalysis of a small amount of alkali catalyst to obtain aerogel wet glue particles. This patent can use stirring speed, condensation reaction rate, hydrolysis solution content, dispersion solution content to control the particle size and internal microstructure of the prepared aerogel wet glue particles; (3) a solvent drying recovery step: after the gel structure of the aerogel wet gel particles is stable, then performing high-temperature drying under normal pressure and slow stirring conditions, using the azeotropic theory to vaporize and dry the solvent in the aerogel wet glue structure under high temperature environment, and using the recovery device to condense and recover the gaseous solvent, and the recovered solvent can be reused in the mixing hydrolysis and condensation dispersion steps. Finally, the drying temperature is increased to instantly vaporize a small amount of solvent inside the aerogel and generate a vaporization pressure to promote the expansion of the aerogel structure to obtain aerogel particles with higher porosity and high purity.

In addition, it is in order to solve the problem of uneven mixing of low-density aerogel particle and polymer solution in the preparation technology of low-dielectric aerogel/polymer composite materials or composite membranes and the phenomenon that the polymer solution easily penetrates into the interior of the aerogel; especially hydrophobic aerogel particle mixed with various polymer solutions is almost impossible to disperse. Therefore, in another embodiment of the present invention, the aerogel particles under the drying condition of 80% to 95% (slightly containing solvent) are mixed with an organic solvent to form an aerogel suspension containing the organic solvent, and the use of slightly solvent-containing aerogel particle can be easily mixed with various polymer solutions matched with the solvent to form a uniform aerogel/polymer suspension solution without agglomeration. Its process technology includes the following steps: (4) an organic solvent suspension dispersion step: using organic solvents such as toluene, methyl ethyl ketone, absolute alcohol or other solvents to suspend and disperse the previously dried aerogel particles or the slight wet aerogel particles dried to a 80% to 95% dried condition so that the aerogel particles form a uniformly dispersed aerogel suspension dispersion in an organic solvent; (5) a polymer solution mixing step: utilizing the polymer solution such as polyphenylene ether (PPE) solution and polytetrafluoroethylene (PTFE) solution of toluene solvent, epoxy resin solution of butanone solvent, polyimide (PI) solution of absolute alcohol, and water-based acrylic (PMMA) solution or water-based polyurethane (PU) of water solvent, with the same solvent such as toluene, butanone, absolute alcohol or other solvents used in the uniformly dispersed aerogel suspension dispersion so that the uniformly dispersed aerogel suspension dispersion can be easily mixed with various polymer solutions matched with the solvent to form a uniformly dispersed aerogel/polymer solution; (6) a coating film formation step: using coating technology, laminating technology, extrusion technology or drawing film technology to make the uniformly dispersed aerogel/polymer solution coat or laminate to form film, and then using high-temperature rollers for surface drying and film thickness shaping to form a uniform thickness of aerogel/polymer surface dry-wet thin film or aerogel/polymer surface dry-wet thick film; (7) a drying and winding step: finally, using the air extraction heating channel or multiple sets of heating rollers to dry and shape the aerogel/polymer surface dry-wet thin film or aerogel/polymer surface dry-wet thick film with uniform thickness, then winding the dried and shaped aerogel/polymer thin film or aerogel/polymer thick film with traditional winding equipment, and the aerogel/polymer thin film or aerogel/polymer thick film can be obtained by this process technology.

The process technology of the present invention can rapidly produce aerogel particles or aerogel/polymer thin film or aerogel/polymer thick film with high purity and low-dielectric constant. In the aerogel particle process, no surfactants, metal oxides and other additives are added, and the content of acid-base catalyst ions is controlled at a very low concentration during the process, and there is no need for steps such as solvent replacement, water washing and supercritical drying. Therefore, the overall manufacturing process is simple, the aerogel manufacturing cost can be significantly reduced, and high-purity aerogel particle products can be obtained. On the other hand, the process technology of the present invention provides another embodiment that can quickly and easily mix with the polymer solution uniformly and prepare an aerogels/polymer film of tens to hundreds of microns or aerogels/polymer sheet with a thickness of several millimeters to centimeters. The overall process of composite processing is simple, fast, economical, and the product has high purity, thereby improving the production efficiency of low-dielectric high-purity aerogel and aerogel/polymer composite thin film or composite thick plate.

Further, the alkoxysilane compound is one or more substances selected from the group consisting of tetramethoxysilane (TMOS) and tetraethoxysilane (TEOS), and the hydrophobic modified alkoxysilane compound is one or more substances selected from the group consisting of methyltrimethoxysilane (MTMS) and methyltriethoxysilane (MTES); the addition of the alkoxysilane compound in this technology is mainly to provide and regulate the internal porosity of the aerogel and the fine structure of its gel network structure. Therefore, the higher the content of siloxane compound added in this technology will induce the higher the porosity inside the aerogel and the more complete the aerogel network structure, but the shrinkage rate will also be significantly improved; on the contrary, adding the hydrophobically modified siloxane compound is mainly to reduce the shrinkage and cracking of the aerogel structure during the drying process. Therefore, the higher the content of the hydrophobically modified siloxane compound added in this technology will induce the higher the hydrophobic property inside the aerogel and improve the low-dielectric property of the aerogel product, but the porosity inside the aerogel particle decreases.

Further, in the mixed hydrolysis step, when the content ratio of the acid catalyst in the mixed solution is higher, the hydrolysis rate is faster. But containing a large amount of acid ions will produce ionic dielectric properties under the action of an electric field, so it will improve the dielectric properties of the aerogel, that is, the dielectric loss of the aerogel will be higher. Relatively, the lower the content ratio of the acid catalyst will induce the slower the overall hydrolysis rate. In this technology, increasing the temperature can also be used to increase the hydrolysis rate of acid ions. In addition, during the preparation process, the aerogel is prepared with deionized water or solvent recovered from the process, which can reduce the influence of related ions on the dielectric properties of the aerogel.

Further, in the dispersion condensation step, the emulsifiers, homogenizers, turbo mixers or other fast stirring purposes are used in order to accelerate the hydrolyzed silicon molecule dispersion solution under high-speed stirring to disperse into nano-scale to sub-micron silicon-containing molecules to form round fine silicon-containing molecular wet-sol droplets, and a small amount of alkali catalyst system is added in the dispersion condensation step to make the sub-micron silicon-containing molecules disperse inside the round fine silicon-containing molecular wet-sol droplets to catalyze and accelerate the condensation in the alkaline catalyst, so as to promote the condensation of the silicon-containing molecule dispersion solution to form a sol and further form a stable gel. In addition, due to the addition of a small amount of organic solvent compatible with the surface of the aerogel during the manufacturing process, the solvent forms an organic solvent liquid film on the surface of the aerogel, and the dispersing solvent incompatible with the organic solvent is used for condensation and dispersion. Therefore, a large amount of dispersing solvent is used to make the condensed aerogel structure avoid the aggregation of round fine silicon-containing molecular wet-sol droplets in the solution condensation reaction to form a single aerogel round fine wet glue aerogel particle. In this dispersion condensation step, there is no need to add emulsifier, surfactant or suspension dispersion stabilizer, and no various additives need to be added in the preparation process, so that the purity of the aerogel product is the highest.

Further, in the solvent drying recovery step, after the gelation is stabilized, the dispersion solution of aerogel round fine wet glue particles is firstly filtered to remove most of the dispersion solvent, and the dispersion solvent is recycled for reuse. The filtered aerogel round fine wet glue particles are subjected to azeotropic evaporation and vaporization of the solvent inside the aerogel particles under normal pressure and high temperature environment. Therefore, the solvent content in the solvent drying recovery process of this technology is significantly reduced, the process is relatively safe and high-purity aerogel products can be prepared. The low-density and high-porosity aerogel particle prepared by this technology does not contain various impurities inside and on the surface, so the product has excellent low-dielectric constant and low-dielectric loss.

Further, according to the preparation method provided by the present invention, wet aerogel round fine wet glue particles can be further prepared, the aerogel round fine wet glue particles only contain 3-10 vol % trace solvent, and the aerogel round fine wet glue particles are especially suitable for improving the problem of uneven dispersion caused by mixing lightweight aerogel with various polymers or polymer concentrated solutions. According to the preparation method of mixing the polymer-compatible organic solvent, the aerogel round fine wet glue particles in the drying process can be quickly suspended and dispersed subsequently to form an organic solvent-containing aerogel suspension.

Further, the organic solvent suspension dispersion step: the internal mixed solvent inside the above dried aerogel particle or the slightly solvent-containing wet aerogel round fine particles dried to a 80% to 95% dried condition and the affinity and repellency properties of the surface of the micro-particles are utilized, and the use of organic solvents that are similar in affinity of the surface of the aerogel round fine particles but repellent to the inside of the aerogel round fine particles is used to disperse the aerogel round fine particles, so that the aerogel round fine particles are dispersed during the dispersion process to form a homogeneously dispersed suspension.

Further, the polymer solution mixing step: the uniformly suspended and dispersed aerogel round fine particles are mixed with the polymer solution comprising a solvent with a surface solubility parameter or compatibility similar to it; for example, the polymer solution can be polyphenylene ether (PPE) solution, polytetrafluoroethylene (PTFE) solution, polyester (PET, or PEN) and polyimide (PI) solution and its solvent is toluene, xylene, hexane and methylpyrrolidone; another example is that the polymer whose solvent is butanone, dimethylacetamide solvent and methylpyrrolidone solvent can be epoxy resin (Epoxy), acrylic (PMMA) solution, polyurethane (PU) and other solutions; another example is a polyimidic acid (PAA) solution in which the solvent is ethanol or absolute ethanol; finally, another example is water-based acrylic (PMMA) solution or water-based polyurethane (PU) solution in which the solvent is water. By using the above, the uniformly dispersed aerogel round fine particles can be easily mixed with the surface-matched or compatible polymer solution to form a uniformly dispersed aerogel/polymer composite solution.

Further, coating film forming step: the uniformly dispersed aerogel/polymer composite solution can be coated, pressure suctioned, laminated, extruded, drawn to form a uniform thickness of aerogel/polymer wet thin film or aerogel/polymer wet film. Subsequently, the surface drying of the aerogel/polymer wet thin film or the aerogel/polymer wet film and the shaping of the film thickness are further carried out by using an exhaust infrared heating plate, an ultraviolet curing machine or multiple sets of high-temperature rollers.

Further, drying and winding step: finally, the aerogel/polymer surface dry-wet thin film or aerogel/polymer surface dry-wet thick film with uniform thickness is finally dried and shaped by using the high-temperature heating channel or multiple sets of high-temperature heating rollers. Then, the dried and shaped aerogel/polymer thin film or aerogel/polymer film is rolled up with traditional winding equipment, and the aerogel/polymer thin film or aerogel/polymer film can be obtained by this process technology. The above preparation technology can be used to prepare low-dielectric aerogel composite materials, such as low-dielectric layers used in high-frequency circuits, insulating layers in semiconductor devices, or microwave circuits in communication integrated circuits.

Furthermore, in the low-dielectric aerogel composite material, the higher the content of the low-dielectric aerogel in the preparation process will induce the greater the efficiency content of the inner pores of the aerogel in the low-dielectric aerogel composite material, so as to make the better the dielectric properties and the poorer the physical properties of low-dielectric aerogel composites, such as strength, toughness, and rigidity; on the other hand, the lower the low-dielectric aerogel content will induce the higher the polymer content in the low-dielectric aerogel composite, so as to make the better the physical properties of the low-dielectric aerogel composite, but the worse the low-dielectric. Therefore, the properties of the product can be adjusted by adding low-dielectric aerogel content.

On the whole, the process is simple, low in manufacturing cost, fast in process speed, and does not need to use long-term solvent replacement and long-term water washing steps, and does not need to use complex process technologies such as supercritical drying. The batch process speed of the developed aerogel composite sheet can be reduced to a few hours to complete, or the aerogel polymer composite film or sheet can be prepared in a continuous production mode, thereby improving production efficiency.

The present invention has the following effects:
1. The preparation method provided by the present invention modifies the traditional sol-gel reaction process to prepare aerogel particle. Because there is no need to add a large amount of organic solvents, emulsifiers, surfactants, suspension dispersion stabilizers, adhesives and other substances in the process, there is no need to use long-term solvent replacement or use deionized water to wash out various impurities or ions during the manufacturing process. Therefore, the overall manufacturing process is simple and has economic and competitive advantages.
2. The preparation method provided by the present invention utilizes rapid dispersion equipment, such as emulsifiers and homogenizers, in the condensation dispersion process to carry out rapid suspension dispersion with a very small amount of hydrophobic solvent and a large amount of ethanol-containing deionized water, so that the hydrolyzed solution containing siloxane compounds can be rapidly dispersed to form a suspension dispersion of aerogel round fine wet glue particles under dispersion. In this technology, only the aerogel round fine solution wet-sol droplets are used to gradually form solid-like gel fine particles during the gelation process, and the difference in compatibility between the solvent in the aerogel round fine wet glue particles and a large amount of dispersion solvent is also utilized to form stable gel fine particles. Therefore, aerogel particles with high purity and excellent low-dielectric properties can be easily prepared without adding emulsifiers, surfactants, and suspension dispersion stabilizers.
3. In the preparation method provided by the present invention, the porosity, pore size and compactness of the aerogel structure can be easily adjusted by using different proportions of siloxane compounds or hydrophobically modified siloxane compounds, the content of a large amount of hydrolysis solvent, the content and proportion of acid catalysts and alkali catalysts, etc. In addition, using the stirring speed of emulsifiers, homogenizers and other dispersing equipment combined with a large amount of dispersing solvent content can easily control the agglomeration properties of aerogel particles, so as to improve the practical properties of aerogel.
4. In the preparation method provided by the present invention, the internal mixed solvent inside the slightly solvent-containing aerogel round micro-particles and the affinity and repellency properties of the surface of the micro-particles are utilized, and the use of organic solvents that are similar in affinity of the surface of the aerogel round fine particles but repellent to the inside of the aerogel round fine particles is used to disperse the aerogel round fine particles, so that the aerogel round fine particles are dispersed during the dispersion process to form a homogeneously dispersed suspension. The slightly solvent-containing aerogel round fine particle suspension dispersion can be further mixed with various polymer organic solutions to prepare a uniformly dispersed aerogel/polymer composite solution, and then a uniform low-dielectric aerogel/polymer composite materials can be quickly prepared, especially low-dielectric aerogel/polymer composite products for 5G or 6G high-frequency applications.
5. In the preparation method provided by the present invention, the slightly solvent-containing aerogel round fine wet glue particle suspension dispersion containing an organic solvent is mixed with the polymer solution to make the aerogel suspension and the polymer chain disperse uniformly in a solvent environment so as to produce the aerogel/polymer composite material containing aerogel particles, and the low-dielectric properties of aerogel/polymer composites change significantly with the increase of internal pores or aerogel content. When the polymer content is lower, the content of polymer-mixed aerogel is higher. The internal hole efficiency of the aerogel/polymer composite material is better, and the low-dielectric properties are obviously reduced; but the physical properties of the aerogel/polymer composite material will decline; on the contrary, the higher the polymer content in the aerogel/polymer composite will induce the better the strength of the prepared low-dielectric aerogel/polymer composite. Therefore, the low-dielectric coefficient and strength of the prepared low-dielectric aerogel/polymer composite material can be further controlled by the content of aerogel and polymer solution.
6. In the preparation method provided by the present invention, various polymer solutions can be mixed to prepare low-dielectric aerogel/polymer composite materials with different properties, so as to regulate the strength of low-dielectric aerogel/polymer composite materials, durable temperature, bonding with other materials, product dielectric constant (about 1.3 to 2.5) and dielectric loss (0.0005 to 0.001) and other properties.
7. In the preparation method provided by the present invention, the added acid catalyst and alkali catalyst can accelerate the hydrolysis and condensation reaction of siloxane and hydrophobically modified siloxane, wherein the molar ratio of the total content of the siloxane and the hydrophobically modified siloxane mixture to the acid catalyst content in the reaction system of the acid catalyst is from 1:0.001 to 1:0.00005; in the condensation reaction, the molar ratio of the acid catalyst to the base catalyst is from 1:0.7 to 1:1.8. The higher the content of acid catalyst and alkali catalyst in the mixed solution will induce the faster the reaction rate; relatively, the higher the content of acid catalyst and alkali catalyst will induce the higher the ion content in the overall aerogel structure, and the dielectric loss of the aerogel will be greater, so as to adjust the process speed and product properties.

### BRIEF DESCRIPTION OF THE DRAWINGS

FIG. 1 is a schematic diagram showing the process flow of the low-dielectric aerogel particle according to the first embodiment of the present invention.

FIG. 2 is an appearance image of the low-dielectric aerogel particle prepared in the first embodiment of the present invention.

FIG. 3 is a scanning electron microscope micrograph of the low-dielectric aerogel particle prepared in the first embodiment of the present invention.

FIG. 4 is an appearance image of the low-dielectric aerogel/polyimide composite film prepared in the second embodiment of the present invention.

FIG. 5 is a scanning electron microscope micrograph of the low-dielectric aerogel/polyimide composite film prepared in the second embodiment of the present invention.

FIG. 6 is an appearance image of the low-dielectric aerogel/silicone composite film prepared in the third embodiment of the present invention.

FIG. 7 is a scanning electron microscope micrograph of the low-dielectric aerogel/silicone composite film prepared in the third embodiment of the present invention.

### DETAILED DESCRIPTION OF THE INVENTION

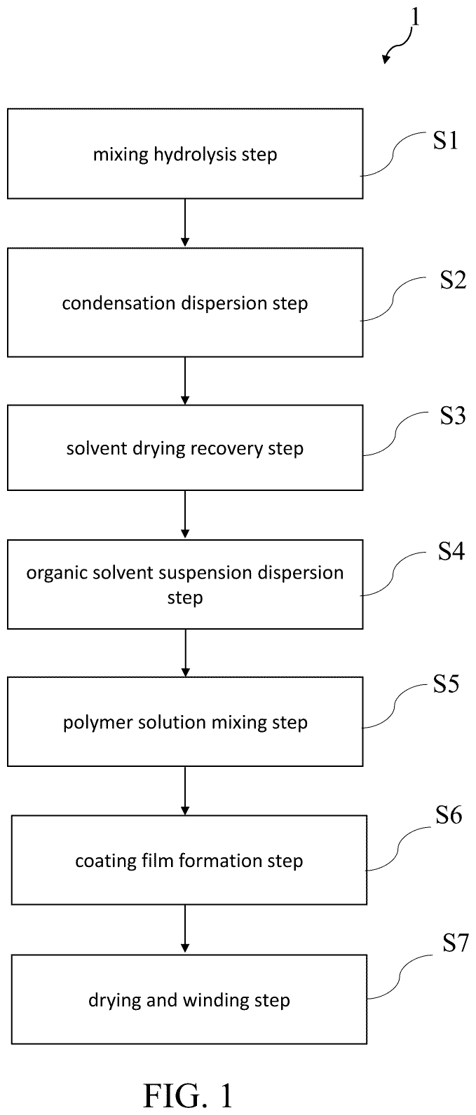

Referring to FIG. 1, the method for preparing a low-dielectric aerogel particle and aerogel/polymer composite film of the present invention is disclosed, which includes the following steps: a mixing hydrolysis step (S1), a condensation dispersion step (S2), a solvent drying recovery step (S3), an organic solvent suspension dispersion step (S4), a polymer solution mixing step (S5), a coating film formation step (S6), and a drying and winding step (S7), wherein:

The mixing hydrolysis step (S1) comprises: mixing a siloxane compound or a hydrophobically modified siloxane compound with a large amount of ethanol aqueous solution containing a small amount of acid catalyst, and performing a hydrolysis reaction during the mixing process to form a hydrolysis solution containing silicon molecules, wherein the siloxane compound (alkoxysilane) includes tetramethoxysilane (TMOS), tetraethoxysilane (TEOS) or a combination thereof, and the hydrophobically modified siloxane compound includes hydrophobic methyltrimethoxysilane (MTMS), methyltriethoxysilane (MTES) or combinations thereof; the purpose of adding the hydrophobically modified siloxane is to reduce the cracking of the aerogel structure during the drying process, and the purpose of adding the siloxane is to regulate the internal microstructure of the aerogel structure to increase the content of holes in the structure.

In some embodiments, in terms of the overall mixed solution, the molar percentage of the total content of the siloxane compound and the hydrophobically modified siloxane is between 0.5 mol % and 50 mol %, and the total content mole percentage of this slightly containing solvent and ethanol aqueous solution is between 99.5 mol % and 50 mol %; in some embodiments, the molar ratio of the siloxane compound to the hydrophobic modified siloxane compound is from 0:100 to 45:55; in a preferred embodiment, the molar ratio of the siloxane compound to the hydrophobic modified siloxane compound is 12.5:87.5. In the ethanol aqueous solution, the molar ratio of organic solvent to ethanol to water is from 3:5:92 to 5:45:50; in a preferred embodiment, the molar ratio of organic solvent to ethanol to water is 5:15:80.

In the process of fully mixing the siloxane compound or the hydrophobic modified siloxane compound with a large amount of alcoholic water containing a small amount of acid catalyst, the hydrolysis reaction is carried out at the same time, wherein the solvent of the acid catalyst ethanol aqueous solution includes ethanol, deionized water, recovered ethanol solution, recovered distilled water, secondary treated water, etc., or a mixture of different compositions, the molar ratio of the total content of the mixture of the siloxane compound and hydrophobic modified siloxane compound to the content of the acid catalyst is from 1:0.01 to 1:0.00005. When the content ratio of the acid catalyst in the mixed solution of the siloxane and the hydrophobically modified siloxane is higher, the hydrolysis rate is faster; in other words, the higher the content ratio of the acid catalyst will induce the greater the ion content in the overall aerogel structure so as to result in the greater the dielectric loss of the aerogel; in a preferred embodiment, the mol ratio of the total content of the mixture of siloxane and hydrophobically modified siloxane to the content of the acid catalyst is 1:0.0015.

In the condensation dispersion step (S2), adding the silicon-containing molecular hydrolysis solution to a large amount of dispersed ethanol aqueous solution containing a small amount of alkali catalyst with combining the emulsifier, homogenizer and other high-speed stirring equipment under high-speed stirring and dispersing conditions to make the silicon-containing molecular hydrolysis solution form nano-scale suspended silicon-containing molecular wet-sol droplets and carry out condensation reaction, then utilizing stirring and carrying out condensation reaction at a condensation reaction temperature to obtain a low-dielectric aerogel dispersion suspension, and making the low-dielectric aerogel wet-sol droplets or particles suspend and disperse in the suspension solvent; it should be further explained that in the condensation reaction, the obtained aerogel structure can be controlled by controlling the condensation reaction temperature and adding a large amount of dispersed ethanol aqueous solution to adjust the condensation reaction rate. The addition of a large amount of dispersed ethanol aqueous solution can utilize one or a mixture of different compositions of recovered ethanol-containing aqueous solution, recovered distilled water, recovered secondary treated water, and deionized water, etc. In some embodiments, adding a large amount of dispersing water can accelerate nanoscale to submicron-scale silicon-containing molecules to disperse to form round fine silicon-containing molecular wet-sol droplets so as to form gelation and accelerate curing. It can promote the condensation of the silicon-containing molecular dispersion solution to form a sol and further form a stable gel. In addition, due to the addition of a small amount of organic solvent compatible with the surface of the aerogel during the manufacturing process, the solvent forms an organic solvent liquid film on the surface of the aerogel, and the dispersing solvent incompatible with the organic solvent is used for condensation and dispersion. Therefore, a large amount of dispersing solvent is used to make the condensed aerogel structure avoid the aggregation of round fine silicon-containing molecular wet-sol droplets in the solution condensation reaction to form a single low-dielectric aerogel round fine wet glue particle, and there is no need to add emulsifier, surfactant or suspension dispersion stabilizer. Because there is no need to add various additives in the preparation process, the purity of the aerogel product is the highest.

In condensation dispersion, the promotion of temperature helps to shorten the condensation reaction time obviously, that is to say, the gelation time of aerogel is effectively shortened in this dispersion condensation step (S2); wherein when the content equivalent ratio of the alkali catalyst to the acid catalyst is 1.0:1.0, the condensation reaction temperature is 20-55° C., and the condensation reaction time is 20-250 minutes; in some preferred embodiments, the condensation reaction temperature is 25° C., and the condensation reaction time is about 220 minutes; when the condensation reaction temperature is 50° C., the condensation reaction time is about 25 minutes.

In some other embodiments, the increase of the alkali catalyst content will also obviously shorten the condensation reaction time, wherein the content equivalent number ratio of 1.0M alkali catalyst to 1.0M acid catalyst is from 0.8:1.0 to 2.0:1.0, and the condensation reaction time about 360˜2 minutes; in some embodiments, the content equivalent ratio is 0.8:1.0, and the condensation reaction time is 360 minutes; in other preferred embodiments, the equivalent ratio of the content is 1.6:1.0, and the condensation reaction time is about 5 minutes; it should be further explained that when the content equivalent ratio is less than 1.0:1.0, the condensation reaction time will gradually increase, and the dielectric loss of the prepared aerogel will decrease significantly; when the content equivalent ratio is greater than 1.0:1.0, the condensation reaction time will gradually decrease, but the dielectric loss of the prepared aerogel will increase significantly due to the ion content; in a preferred embodiment of this embodiment, the content volume ratio is 1.4:1.0.

The solvent drying recovery step (S3): after the dispersion suspension of the low-dielectric aerogel wet-sol droplets round fine wet glue particles is stable, the dispersion solution of the aerogel round fine wet glue particles is firstly filtered to remove most of the dispersion solvent, and the dispersion solvent is recovered and reused. The filtered aerogel round fine wet glue particles are used in a dry recovery system under normal pressure and high temperature, and the ethanol-containing water solvent inside the aerogel particle system is azeotropically evaporated and vaporized at an azeotropic temperature to obtain a 90% to 97% dried low-dielectric and slightly solvent-containing wet aerogel round fine particles, and the solvent in the process is recycled and reused. Therefore, the solvent content in the solvent drying recovery process of this technology is significantly reduced, and the process is relatively safe and high-purity aerogel products can be prepared. In some embodiments, the evaporation temperature is 110-150° C.

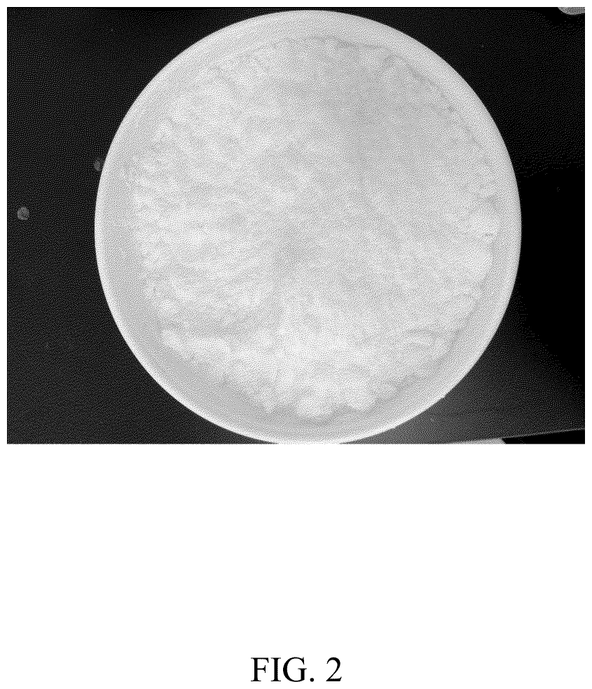

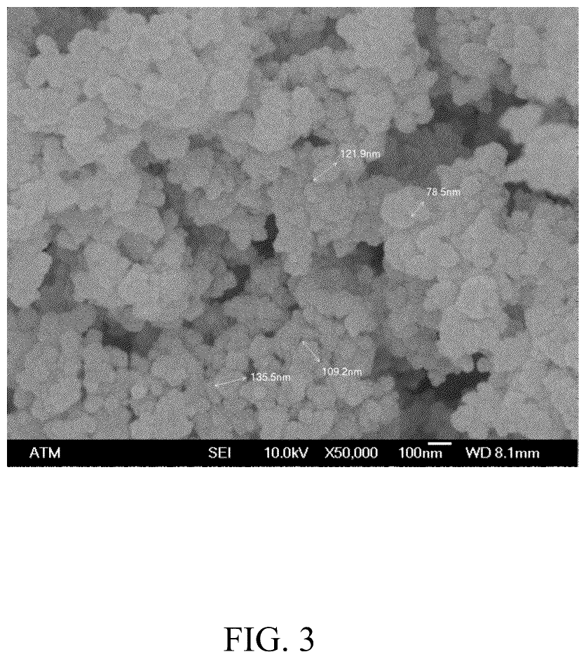

Please refer to FIG. 2, which is the aerogel particle or the wet aerogel round fine particle with a slight solvent content under the drying condition of 90% to 97% prepared according to the above-mentioned preparation method, and its appearance is a white wet aerogel particle structure; please refer to FIG. 3, which is a scanning electron microscope image of the low-dielectric aerogel particle prepared according to the aforementioned preparation method; under the electron microscope, the microstructure of the circular fine particles of the slightly solvent-containing wet aerogel under a dry condition of 90% to 97% dryness presents a uniform spherical structure with a size ranging from about 100 nanometers to submicron-meters, and then uses about 100 nanometer aerogel particles to aggregate into sub-micron to micron-scale aggregates; in addition, it can be seen from FIG. 3 that there are a large number of microscopic pores in the aerogel aggregate structure, which form the porosity of the aerogel particle.

Furthermore, it is the second embodiment of the present invention, wherein the solvent drying recovery includes a vaporization step (S3-1) and a solvent recovery step (S3-2).

In the vaporization step (S3-1), the vaporization temperature of the aerogel system is adjusted to the azeotropic temperature of a mixed solvent, so that a small amount of organic solvent contained in the aerogel and a large amount of ethanol and water molecules can produce rapid bumping under two-phase azeotropic or three-phase azeotropic conditions; in some embodiments, the ethanol-water two-phase azeotropic temperature is between 65° C. and 68° C.; the ethanol-water-toluene three-phase azeotropic temperature is between 73° C. and 78° C. It should be further explained that under the high-temperature environment created by the two-phase azeotropic or three-phase azeotropic temperature, and a positive pressure will be generated inside the aerogel, which can inhibit the aerogel structure from shrinking or collapse during the drying process; on the other hand, the positive pressure makes the aerogel porous; in some embodiments, the vaporization temperature is between 75° C. and 120° C.

In the solvent recovery step (S3-2), the vaporization temperature is adjusted to the azeotropic temperature of the mixed solvent, so that the trace amount of organic solvent contained in the aerogel and a large amount of ethanol and water molecules can form a bump phenomenon of two-phase azeotropic or three-phase azeotropic conditions; then, all the two-phase azeotropic or three-phase azeotropic solvents are recovered and reused by a condensation recovery device, so that a 90% to 97% dried and slightly solvent-containing wet aerogel round fine particle is formed. In some embodiments, the solvent recovery device is a water-cooled condensing device, which can recover and reuse 85% to 95% of the solvent in the process, so as to reduce air pollution and reduce manufacturing costs.

The organic solvent suspension dispersion step: the affinity and repellency properties of the surface and the inside of the above dried aerogel particle or the slightly solvent-containing wet aerogel round fine particles dried to a 80% to 95% dried condition are utilized, and the use of organic solvents that are similar in affinity of the surface of the aerogel round fine particles but repellent to the inside of the aerogel round fine particles is used to disperse the aerogel round fine particles, so that the aerogel round fine particles are dispersed during the dispersion process to form a homogeneously dispersed suspension. In some embodiments, in the organic solvent suspension and dispersion step, the volume solid content of the uniformly suspended and dispersed aerogel round fine particles is about 20 to 75%. In a preferred embodiment, the volume solid content of the uniformly suspended and dispersed aerogel round fine particles is about 35 to 45%.

The organic solvent added in the step of suspending and dispersing the aerogel round fine particles can be formulated according to the solubility parameters matched with the surface properties of the fine particles or organic solvents with similar compatibility or a mixture thereof. The trace organic solvent is composed of toluene, xylene, hexane, cyclohexane, NMP, 2-butanone, MEK, acetone (Acetone), N, N-dimethylacetamide (DMAC), ethyl acetate, ethanol, absolute ethanol and deionized water or a combination thereof or two or more combination.

The polymer solution mixing step (S5): the suspended and dispersed aerogel round fine particles whose surface solubility parameter or compatibility is similar matched with solvent used in the polymer solution are mixed with the polymer solution; for example, the solvent-matched polymer solution can be polyphenylene ether (PPE) solution, polytetrafluoroethylene (PTFE) solution, polyester (PET, or PEN) and polyimide (PI) solution, whose solvent is toluene, xylene, hexane and methylpyrrolidone, etc.; another example is that the solvent is butanone, dimethylacetamide solvent and methylpyrrolidone solvent and the matching polymer solution can be epoxy resin (Epoxy), acrylic (PMMA) solution, polyurethane (PU) and other solutions; another example is a polyimidic acid (PAA) solution that matches ethanol or absolute ethanol as a solvent; finally, the solvent is such as a water-based acrylic (PMMA) solution or a water-based polyurethane (PU) solution that matches water. In some embodiments, the solid content of the polymer solution mixed solution is 20% to 60%, and the uniformly dispersed aerogel circular fine particles can be easily matched or compatible with the surface by using the above polymer solutions to be mixed to form a uniformly dispersed aerogel/polymer composite solution. In some embodiments, in the polymer solution mixing step, the volume ratio of the organic solvent suspension dispersion solution to the polymer solution is from 0.5:1 to 1:0.5. In a preferred embodiment, the volume ratio of the organic solvent suspension dispersion solution to the high polymer solution is 1.0:1.0.

The polymer mixed solution includes thermosetting polymers, liquid crystal polymers, thermoplastic polymers or combinations thereof; specifically, for example: epoxy resin (epoxy), Polyimide (PI), polyetherimide (PEI), polyphenylene ether (PPE), polyphenylene sulfide (PPS), polyether ketone liquid crystal polymer (PEK), polyether ether ketone liquid crystal polymer (PEEK), polypropylene (PP), polyethylene (PE), polycarbonate (PC), polyamide (pPA), polyamide Ester (POLYESTERAMIDE, PEA), polyester (PET), polytetrafluoroethylene (PTFE), acrylic (PMMA) solution, polyurethane (PU), polyimide acid (PAA), water-based pressure Acrylic (PMMA), water-based polyurethane (PU), etc., or other polymers. The solvents for polymer solutions also include toluene, xylene, hexane, cyclohexane, N-methylpyrrolidone, butanone, acetone, N, N-dimethylacetamide, ethyl acetate, ethanol, deionized water or one of its combinations or a combination of two or more.

The coating film forming step (S6): when the uniformly dispersed aerogel/polymer composite solution can be coated or sprayed with the aerogel/polymer composite solution by using techniques such as coating, pressure suction, film coating, extrusion or film pulling. The film forms a low-dielectric aerogel/polymer wet thin film or aerogel/polymer wet composite film of uniform thickness. Subsequently, the setting of the film thickness and the surface drying of the aerogel/polymer wet thin film or the aerogel/polymer wet film are further carried out by using an exhaust infrared heating plate, an ultraviolet curing machine or multiple sets of high-temperature rollers.

In the coating film formation step, the aerogel/polymer solution having a low solid content (solid content is about 20-35%) or a low boiling point of the solvent can be dried by a drying technology with the exhaust infrared heating plate, and the heating temperature is below the boiling point of the solvent about 3-10 degrees and heating for a few seconds to a few minutes; when the aerogel/polymer solution has a high solid content (solid content>65%) or a high boiling point of the solvent, the drying technology uses multiple sets of high-temperature rollers to perform a surface drying and film thickness setting of the aerogel/polymer wet thin film or aerogel/polymer wet film; when the aerogel/polymer solution is heat-cured or UV-cured or the drying technology for a higher boiling point of the solvent, a UV curing machine is used with a high-temperature roller to dry a surface drying and film thickness setting for the aerogel/polymer wet thin film or aerogel/polymer wet film.

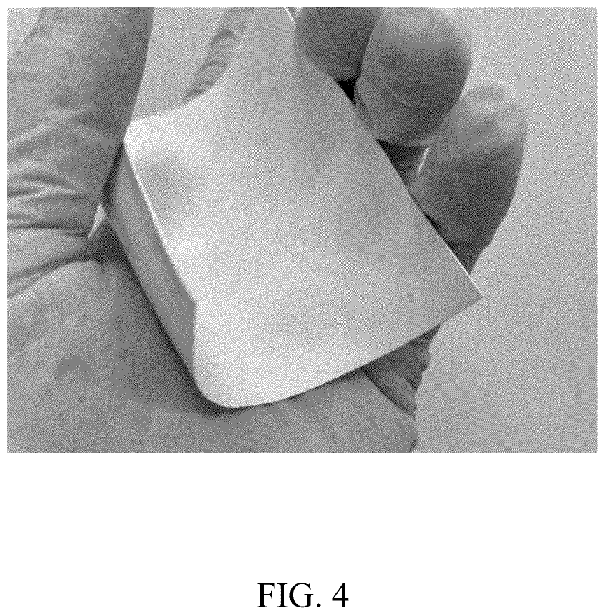

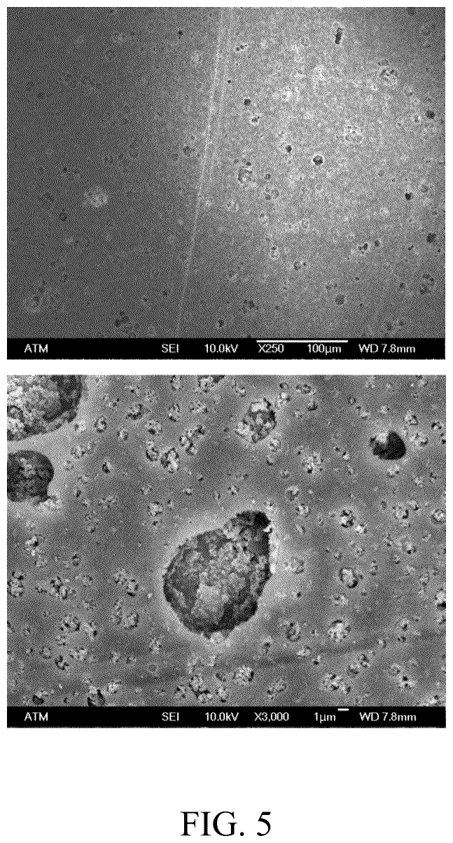

Please refer to FIG. 4, which is the appearance image of the aerogel/polyimide flexible thin film prepared by the second embodiment, which shows that the prepared aerogel/polyimide flexible thin film has soft and flexible properties; please refer to FIG. 5, which is the SEM electron micrographs of the aerogel/polyimide flexible thin films observed under different magnifications. It can be observed from the SEM electron microscope that the surface of the aerogel/polyimide flexible thin film contains a flat appearance with holes with a size of about several microns to ten microns, which can be clearly observed in the holes of the aerogel/polyimide soft thin film that a large amount of aerogel particles is adhered to polyimide. Overall, the aerogel/polyimide flexible thin film is flat and uniform in structure, and contains a large number of aerogel particles with holes and a uniform structure with a size of about 100 nanometers. As a result, the aerogel/polyimide flexible thin film has excellent low dielectric and thermal insulation properties, which has the application potential for the aerogel/polyimide composite film of 5G low dielectric or high temperature resistant thermal insulation.

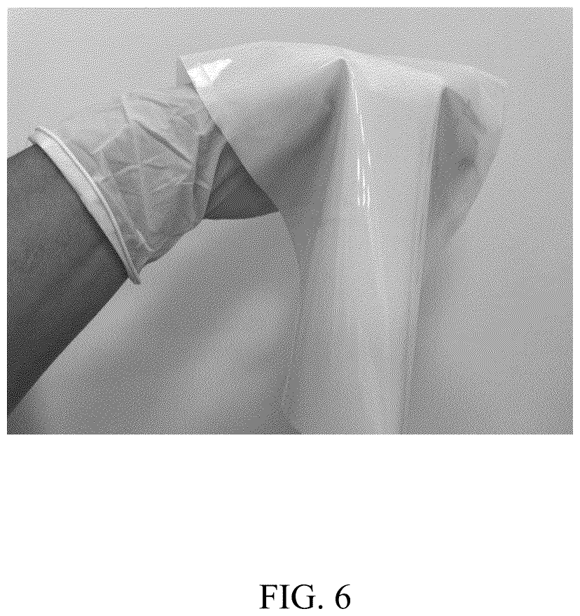

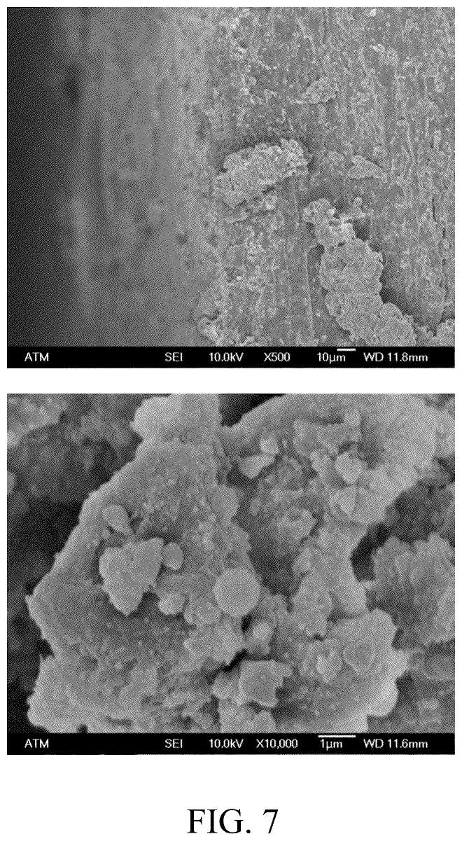

Please refer to FIG. 6, which is the appearance image of the aerogel/silicone soft thin film prepared in the third embodiment, which shows that the prepared aerogel/silicone soft thin film has thinner and softer properties; please refer to FIG. 7, which is the SEM electron micrographs of the aerogel/silicone soft thin films observed under different magnifications. From the SEM electron microscope, it can be observed that the surface and side of the aerogel/silicone soft thin film contain aerogel particles with a size of about tens of nanometers to 100 nanometers; overall, aerogel and silica gel can be mixed uniformly to form an extremely soft aerogel film, which is smooth and uniform in structure and contains a large number of aerogel particles ranging in size from about 100 nanometers to sub-microns, and there are many tiny holes in the aerogel particle structure.

Drying and winding step (S7): finally, the formed aerogel/polymer surface dry-wet thin film or aerogel/polymer surface dry-wet thick film of uniform thickness is finally dried and shaped into an aerogel/polymer film by using high-temperature heating channels or multiple sets of high-temperature heating rollers. Then, the dried and shaped aerogel/polymer thin film or aerogel/polymer film is wound and packaged into rolls or drums using traditional winding equipment. The aerogel/polymer thin film or aerogel/polymer film can be obtained with this process technology, and the above preparation technology can be used to prepare low-dielectric aerogel composite materials used in low-dielectric layers used in high-frequency circuits, insulating layers used in semiconductor devices, or microwave circuits of communication integrated circuits.

According to the description of the above embodiments and examples, the present invention can quickly prepare inorganic aerogel particles with high porosity and low dielectric under normal pressure. Then, the organic solvent is used to uniformly suspend low-dielectric aerogel so as to produce an aerogel suspension, and mixed with polymer solutions to prepare uniform and porous aerogel/polymer composite films, then followed by film heat setting and winding the aerogel/polymer composite films. The preparation method of the low-dielectric aerogel and aerogel/polymer composite film provided by the present invention does not require lengthy solvent replacement and supercritical drying equipment, and the overall manufacturing process is simple, fast, safe and low-cost.

It is to be understood that the foregoing descriptions of the embodiments are given by way of example only, and various modifications may be made by those skilled in the art to which this field pertains. The above specification and examples provide a complete description of the flow of exemplary embodiments of the invention and their uses. Although the above embodiments disclose specific embodiments of the present invention, they are not intended to limit the present invention. Those with ordinary knowledge in the technical field to which the present invention pertains, without departing from the principle and spirit of the present invention, can make various changes and modifications to it, so the protection scope of the present invention should be defined by the appended claims.

What is claimed is:

1. A method for preparing a low-dielectric aerogel/polymer composite film, comprising:
a mixing hydrolysis step: mixing a siloxane compound or a hydrophobically modified siloxane compound with a large amount of an ethanol aqueous solution containing a small amount of acid catalyst and a small amount of organic solvent, and performing a hydrolysis reaction during the mixing process to form a silicon-containing molecular hydrolysis solution;
a condensation dispersion step: adding the silicon-containing molecular hydrolysis solution to a large amount of dispersed ethanol aqueous solution containing a small amount of alkali catalyst, and using an emulsifier and/or homogenizer to make the silicon-containing molecular hydrolysis solution in a large amount of dispersed ethanol aqueous solution containing a small amount of alkali catalyst disperse into nano-scale suspended silicon-containing molecular wet-sol droplets under high-speed stirring and carry out condensation reaction to obtain a dispersion suspended wet-sol droplets of low-dielectric aerogel round fine wet glue particles;
a solvent drying recovery step: after the dispersion suspended wet-sol droplets of low-dielectric aerogel round fine wet glue particles is stable, using a dry recovery system under normal pressure to make the ethanol-containing water solvent in the aerogel wet glue particle system evaporate at an azeotropic temperature so as to obtain a 90% to 97% dried low-dielectric and slightly solvent-containing wet aerogel round fine particles, and the solvent in the process is recovered and reused;
an organic solvent suspension dispersion step: using organic solvent that is similar in affinity of the surface of the aerogel round fine particles but repulsive to the inside of the aerogel round fine particles to disperse the aerogel round fine particles so as to form a uniformly dispersed suspension during the dispersion process based on the affinity and repellency properties of the inside and the surface of the aerogel round fine particles;
a polymer solution mixing step: mixing the suspended and dispersed aerogel round fine particles with a polymer solution matched with solvent having similar surface solubility parameters or compatibility for the suspended and dispersed aerogel round fine particles to form a uniformly dispersed aerogel/polymer composite solution;
a coating film formation step: coating or laminating the aerogel/polymer composite solution to form an aerogel/polymer wet film of uniform thickness; and
a drying and winding step: drying and shaping the formed aerogel/polymer wet film of uniform thickness into an aerogel/polymer film, and then winding the dried and shaped aerogel/polymer film into a roll or tube.

2. The method as claimed in claim 1, wherein the siloxane compound is tetramethoxysilane (TMOS) or tetraethoxysilane (TEOS), and the hydrophobic modified siloxane compound is methyltrimethoxysilane (MTMS) or methyltriethoxysilane (MTES); the molar percentage of the total content of the siloxane compound and the hydrophobically modified siloxane is between 0.5 mol % and 50 mol %; the molar ratio of the siloxane compound to the hydrophobic modified siloxane compound is from 0:100 to 45:55; in the ethanol aqueous solution, the molar ratio of organic solvent to ethanol to water is from 3:5:92 to 5:45:50.

3. The method as claimed in claim 1, wherein the molar ratio of the total content of the siloxane and the hydrophobically modified siloxane mixture to the content of the acid catalyst is from 1:0.01 to 1:0.00005, and the molar ratio of the alkali catalyst to the acid catalyst is from 0.8:1.0 to 2.0:1.0.

4. The method as claimed in claim 1, wherein the condensation dispersion step: adding a large amount of dispersed ethanol aqueous solution, and stirring rapidly with the emulsifier and/or the homogenizer to suspend and disperse the low-dielectric aerogel wet-sol droplets or particles in the suspension solvent, wherein the addition of a large amount of dispersed ethanol aqueous solution can use one or a mixture of different compositions of recovered ethanol-containing aqueous solution, recovered distilled water, recovered secondary treated water and deionized water; and the solvent drying recovery step: controlling the ambient temperature at the azeotropic temperature, and making the suspension solvent and the water molecules in the low-dielectric aerogel wet-sol droplets or particles be in a two-phase or three-phase azeotropic condition, so as to dry the low-dielectric aerogel wet-sol droplets or particles to a 90% to 97% dried condition to form the low-dielectric and slightly solvent-containing wet aerogel round fine particles to obtain a stable aerogel suspension, wherein the organic solvent used in the organic solvent suspension dispersion step is selected from toluene, xylene, hexane, cyclohexane, N-methylpyrrolidone, butanone, acetone, N, N-dimethylacetamide, acetic acid ethyl ester, absolute ethanol, deionized water and a combination thereof.

5. The method as claimed in claim 2, wherein the condensation dispersion step: adding a large amount of dispersed ethanol aqueous solution, and stirring rapidly with the emulsifier and/or the homogenizer to suspend and disperse the low-dielectric aerogel wet-sol droplets or particles in the suspension solvent, wherein the addition of a large amount of dispersed ethanol aqueous solution can use one or a mixture of different compositions of recovered ethanol-containing aqueous solution, recovered distilled water, recovered secondary treated water and deionized water; and the solvent drying recovery step: controlling the ambient temperature at the azeotropic temperature, and making the suspension solvent and the water molecules in the low-dielectric aerogel wet-sol droplets or particles be in a two-phase or three-phase azeotropic condition, so as to dry the low-dielectric aerogel wet-sol droplets or particles to a 90% to 97% dried condition to form the low-dielectric and slightly solvent-containing wet aerogel round fine particles to obtain a stable aerogel suspension, wherein the organic solvent used in the organic solvent suspension dispersion step is selected from toluene, xylene, hexane, cyclohexane, N-methylpyrrolidone, butanone, acetone, N, N-dimethylacetamide, acetic acid ethyl ester, absolute ethanol, deionized water and a combination thereof.

6. The method as claimed in claim 3, wherein the condensation dispersion step: adding a large amount of dispersed ethanol aqueous solution, and stirring rapidly with the emulsifier and/or the homogenizer to suspend and disperse the low-dielectric aerogel wet-sol droplets or particles in the suspension solvent, wherein the addition of a large amount of dispersed ethanol aqueous solution can use one or a mixture of different compositions of recovered ethanol-containing aqueous solution, recovered distilled water, recovered secondary treated water and deionized water; and the solvent drying recovery step: controlling the ambient temperature at the azeotropic temperature, and making the suspension solvent and the water molecules in the low-dielectric aerogel wet-sol droplets or particles be in a two-phase or three-phase azeotropic condition, so as to dry the low-dielectric aerogel wet-sol droplets or particles to a 90% to 97% dried condition to form the low-dielectric and slightly solvent-containing wet aerogel round fine particles to obtain a stable aerogel suspension, wherein the organic solvent used in the organic solvent suspension dispersion step is selected from toluene, xylene, hexane, cyclohexane, N-methylpyrrolidone, butanone, acetone, N, N-dimethylacetamide, acetic acid ethyl ester, absolute ethanol, deionized water and a combination thereof.

7. The method as claimed in claim 4, wherein the polymer solution comprises a thermosetting polymer, which is selected from a group consisting of epoxy resin (epoxy), polyimide (PI), polyetherimide (PEI), polyphenylene ether (PPE), polyphenylene sulfide (PPS), polyether ketone liquid crystal polymer (PEK), polyether ether ketone liquid crystal polymer (PEEK) and a combination thereof.

8. The method as claimed in claim 5, wherein the polymer solution comprises a thermosetting polymer, which is selected from a group consisting of epoxy resin (epoxy), polyimide (PI), polyetherimide (PEI), polyphenylene ether (PPE), polyphenylene sulfide (PPS), polyether ketone liquid crystal polymer (PEK), polyether ether ketone liquid crystal polymer (PEEK) and a combination thereof.

9. The method as claimed in claim 6, wherein the polymer solution comprises a thermosetting polymer, which is selected from a group consisting of epoxy resin (epoxy), polyimide (PI), polyetherimide (PEI), polyphenylene ether (PPE), polyphenylene sulfide (PPS), polyether ketone liquid crystal polymer (PEK), polyether ether ketone liquid crystal polymer (PEEK) and a combination thereof.

10. The method as claimed in claim 4, wherein the polymer solution comprises a thermoplastic polymer, which is selected from a group consisting of polypropylene (PP), polyethylene (PE), polycarbonate (PC), polyamide (PA), polyamide ester (PEA), polyester, polytetrafluoroethylene (PTFE), acrylic (PMMA) solution, polyurethane (PU), Polyamic acid (PAA), water-based acrylic (PMMA), water-based polyurethane (PU) and a combination thereof.

11. The method as claimed in claim 5, wherein the polymer solution comprises a thermoplastic polymer, which is selected from a group consisting of polypropylene (PP), polyethylene (PE), polycarbonate (PC), polyamide (PA), polyamide ester (PEA), polyester, polytetrafluoroethylene (PTFE), acrylic (PMMA) solution, polyurethane (PU), Polyamic acid (PAA), water-based acrylic (PMMA), water-based polyurethane (PU) and a combination thereof.

12. The method as claimed in claim 6, wherein the polymer solution comprises a thermoplastic polymer, which is selected from a group consisting of polypropylene (PP), polyethylene (PE), polycarbonate (PC), polyamide (PA), polyamide ester (PEA), polyester, polytetrafluoroethylene (PTFE), acrylic (PMMA) solution, polyurethane (PU), Polyamic acid (PAA), water-based acrylic (PMMA), water-based polyurethane (PU) and a combination thereof.

13. The method as claimed in claim 7, wherein the solvent used inside the polymer solution is selected from a group consisting of toluene, xylene, hexane, cyclohexane, N-methylpyrrolidone, butanone, acetone, N, N-dimethylacetamide, ethyl acetate, ethanol, deionized water and a combination thereof.

14. The method as claimed in claim 8, wherein the solvent used inside the polymer solution is selected from a group consisting of toluene, xylene, hexane, cyclohexane, N-methylpyrrolidone, butanone, acetone, N, N-dimethylacetamide, ethyl acetate, ethanol, deionized water and a combination thereof.

15. The method as claimed in claim 9, wherein the solvent used inside the polymer solution is selected from a group consisting of toluene, xylene, hexane, cyclohexane, N-methylpyrrolidone, butanone, acetone, N, N-dimethylacetamide, ethyl acetate, ethanol, deionized water and a combination thereof.

16. The method as claimed in claim 10, wherein the solvent used inside the polymer solution is selected from a group consisting of toluene, xylene, hexane, cyclohexane, N-methylpyrrolidone, butanone, acetone, N, N-dimethylacetamide, ethyl acetate, ethanol, deionized water and a combination thereof.

17. The method as claimed in claim 11, wherein the solvent used inside the polymer solution is selected from a group consisting of toluene, xylene, hexane, cyclohexane, N-methylpyrrolidone, butanone, acetone, N, N-dimethylacetamide, ethyl acetate, ethanol, deionized water and a combination thereof.

18. The method as claimed in claim 12, wherein the solvent used inside the polymer solution is selected from a group consisting of toluene, xylene, hexane, cyclohexane, N-methylpyrrolidone, butanone, acetone, N, N-dimethylacetamide, ethyl acetate, ethanol, deionized water and a combination thereof.

19. The method as claimed in claim 1, wherein the low-dielectric aerogel/polymer composite solution can be coated or laminated by coating, suction, film coating, extrusion or film pulling to form a low-dielectric aerogel/polymer composite film of uniform thickness, and using exhaust infrared heating plate, ultraviolet curing machine or multiple sets of high-temperature rollers to dry the surface and shape the film thickness.

20. The method as claimed in claim 19, wherein the low-dielectric aerogel/polymer composite film is finally dried and shaped by exhausting high-temperature heating channels or multiple sets of high-temperature heating rollers, and coiled and packaged by winding equipment.
